(19) United States
(12) Patent Application Publication
(10) Pub. No.: US 2020/0329745 A1
(43) Pub. Date: Oct. 22, 2020

(54) COMPOSITIONS AND METHODS FOR NEUTRALIZING FOOD PLANT EYE IRRITANTS

(71) Applicant: Chef Grade Products NYC LLC, Weehaken, NJ (US)

(72) Inventors: Connor John Haynes, Salt Lake City, UT (US); Leonard M. Haberman, Cypress, TX (US)

(21) Appl. No.: 16/838,912

(22) Filed: Apr. 2, 2020

Related U.S. Application Data
(60) Provisional application No. 62/835,856, filed on Apr. 18, 2019.
(60) Provisional application No. 62/872,051, filed on Jul. 9, 2019.

(51) Int. Cl. A23L 5/20; A23L 19/00; B26D 7/27

(52) U.S. Cl. CPC A23L 5/276; A23L 19/03; B02C 23/18; A23V 2002/00; B26D 2210/02; B26D 7/27

(57) ABSTRACT

Provided herein are compositions and methods for reducing or inhibiting the release of noxious gases from food products that are capable of generating or emitting volatile lachrymatory agents. Aspects described herein relate to compositions including hydrogen peroxide and methods of using these compositions for reducing or inhibiting the generation of noxious gases or for reducing or inhibiting the release of noxious gases, and thereby for preventing or reducing lachrymatory responses in an individual.

### CROSS REFERENCE TO RELATED APPLICATION

This application claims priority to U.S. Provisional Application No. 62/835,856, filed Apr. 18, 2019, and U.S. Provisional Application No. 62/872,051, filed Jul. 9, 2019, each of which is incorporated by reference in its entirety. Any and all priority claims identified in the Application Data Sheet, or any correction thereto, are also hereby incorporated by reference under 37 C.F.R. § 1.57.

### FIELD

The present disclosure relates to compositions and methods for use in preventing or reducing lachrymatory responses in an individual that result from cutting food products containing volatile gases.

### BACKGROUND

It has long been known that cutting onions or other vegetables while cooking can cause tears and eye irritation. This reaction is due to the release of noxious gases that form when enzymes released from cut vegetable cells interact with compounds present in the vegetable. After formation, the noxious gas is released into the air where it wafts into the eyes of nearby individuals, causing pain, tears, and irritation.

Attempts have been made to find ways to prevent or avoid the resulting tears and irritation. Such attempts have included microwaving the vegetable, freezing the vegetable, cutting the vegetable under running water, cutting the vegetable next to a flame, wiping a lemon on a cutting knife prior to use, and other similar practices that have proved ineffective. Recent efforts directed toward the creation of a tearless onion rely on exceptionally sophisticated and costly methods contributed by growers and molecular biologists, including cross-breeding and genetic engineering techniques.

In addition to these techniques, products have appeared on the market that attempt to combat this eye-irritating gas, including, for example, goggles to prevent exposure of the noxious gas to the eyes or enclosed vegetable choppers that retain formation of noxious gases within a controlled enclosure.

Although such products are effective in blocking or minimizing the amount of noxious gases that reaches the eyes, there are also downsides. Goggles, for example, are effective but unattractive to an appearance-conscious chef. In addition, enclosed vegetable choppers are effective and efficient, but require extra kitchen storage space and are only capable of cutting the vegetable in a single direction.

### SUMMARY

Described herein are compositions and methods for preventing, mitigating, or reducing a lachrymatory response in an individual that results from volatile gases released from cutting of a vegetable. In some embodiments, the methods include contacting the vegetable with a composition that includes an inhibitor of the volatile gas or an inhibitor of an enzyme that generates the volatile gas, thereby preventing or reducing release of the volatile gas from the vegetable when cut.

Some embodiments provided here relate to methods of inhibiting or reducing release of a volatile gas from a food product. In some embodiments, the method includes contacting the food product with a composition that includes an inhibitor of the volatile gas. In some embodiments, the inhibitor of the volatile gas is an oxidant, a protonation agent, an anionic surfactant, or a non-ionic surfactant. In some embodiments, the inhibitor of the volatile gas is hydrogen peroxide, sodium dihydrogen citrate, sodium lauryl sulfoacetate, or alkyl glucoside, such as cetearyl glucoside. In some embodiments, the hydrogen peroxide is present in an amount ranging from about 3 weight percent to about 60 weight percent. In some embodiments, the hydrogen peroxide is present in an amount of about 8 weight percent to about 20 weight percent. In some embodiments, the hydrogen peroxide is present in an amount of about 14 weight percent. In some embodiments, the sodium dihydrogen citrate is present in an amount sufficient for the composition to be at a pH of about 4.7 or lower. In some embodiments, the sodium lauryl sulfoacetate is present in an amount ranging from about 0.01% w/v to about 5% w/v. In some embodiments, the sodium lauryl sulfoacetate is present in an amount of about 0.25% w/v. In some embodiments, the cetearyl glucoside is present in an amount ranging from about 0.01% w/v to about 5% w/v. In some embodiments, the cetearyl glucoside is present in an amount of about 0.25% w/v.

In some embodiments, the volatile gas is a lachrymatory agent. In some embodiments, the volatile gas is an enzymatic product of sulfenic acid. In some embodiments, the volatile gas is syn-propanethial-S-oxide or syn-butanethial S-oxide. In some embodiments, the food product is an onion, a shallot, a garlic, a leek, or a chive. In some embodiments, contacting includes misting, spraying, coating, dusting, dipping, immersing, or soaking the food product with the composition. In some embodiments, the contacting includes cutting the food product with an instrument having the composition thereon. In some embodiments, the instrument is a blade, a knife, a chopper, or a slicer. In some embodiments, contacting the food product with the composition oxidizes the volatile gas and/or oxidizes an enzyme responsible for generating the volatile gas. In some embodiments, contacting the food product with the composition occurs prior to, during, or after processing of the food product. In some embodiments, processing the food product includes slicing, dicing, chopping, cutting, mincing, shearing, crushing, or macerating the food product.

Some embodiments provided herein relate to methods of inhibiting or reducing release of volatile gas from an onion, including spraying the onion with a composition including hydrogen peroxide in an amount of about 3 weight percent to about 60 weight percent, sodium dihydrogen citrate in an amount sufficient such that the composition is at a pH of about 4.7 or lower, sodium lauryl sulfoacetate in an amount of about 0.01% w/v to about 5% w/v, or cetearyl glucoside in an amount of about 0.01% w/v to about 5% w/v, or any combination thereof.

Some embodiments provided herein relate to kits for cutting a food product with reduced release of a volatile gas. In some embodiments, the kit includes an instrument for cutting the food product and a container including a composition that includes an inhibitor of the volatile gas. In some embodiments, the container is an aerosol bottle that includes the composition.

Some embodiments provided herein relate to compositions for use in the inhibition or reduction of a volatile gas from a cut food product. In some embodiments, the composition includes a volatile gas inhibitor. In some embodiments, the composition includes hydrogen peroxide present in an amount ranging from about 3 weight percent to about 60 weight percent. In some embodiments, the composition includes hydrogen peroxide present in an amount ranging from about 8 weight percent to about 20 weight percent. In some embodiments, the sodium dihydrogen citrate is present in an amount sufficient for the composition to be at a pH of about 4.7 or lower. In some embodiments, the sodium lauryl sulfoacetate is present in an amount ranging from about 0.01% w/v to about 5% w/v. In some embodiments, the sodium lauryl sulfoacetate is present in an amount of about 0.25% w/v. In some embodiments, the cetearyl glucoside is present in an amount ranging from about 0.01% w/v to about 5% w/v. In some embodiments, the cetearyl glucoside is present in an amount of about 0.25% w/v.

In some embodiments, the volatile gas includes a lachrymatory agent. In some embodiments, the volatile gas includes syn-propanethial-S-oxide or syn-butanethial S-oxide. In some embodiments, the food product is an onion, a garlic, a shallot, a leek, or a chive. In some embodiments, the composition is formulated as a spray, an aerosol, a mist, or a solution. In some embodiments, the composition is formulated as a solid. In some embodiments, the volatile gas inhibitor is complexed with a starch, a modified starch, a simple sugar, or a modified sugar. In some embodiments, the composition is formulated as a powder. In some embodiments, the composition further includes a stabilizer. In some embodiments, the stabilizer is an alcohol or an acid. In some embodiments, the composition oxidizes the volatile gas when the food product is cut, thereby preventing a lachrymatory response in an individual. In some embodiments, the composition oxidizes an enzyme that generates the volatile gas, thereby preventing generation of the volatile gas. In some embodiments, the enzyme is an alliinase or a lachrymatory factor synthase (LFS).

Some embodiments relate to the following numbered alternatives:

1. A method of inhibiting or reducing the release of a volatile gas from a food product, the method comprising contacting the food product with a composition comprising an inhibitor of the volatile gas.

2. The method of alternative 1, wherein the inhibitor of the volatile gas is an oxidant, a protonation agent, an anionic surfactant, or a non-ionic surfactant.

3. The method of alternative 1, wherein the inhibitor of the volatile gas is hydrogen peroxide, sodium dihydrogen citrate, sodium lauryl sulfoacetate (SLSA), or alkyl glucoside such as cetearyl glucoside.

4. The method of alternative 3, wherein the hydrogen peroxide is present in an amount ranging from about 3 weight percent to about 60 weight percent.

5. The method of alternative 3, wherein the hydrogen peroxide is present in an amount of about 8 weight percent to about 20 weight percent.

6. The method of alternative 3, wherein the hydrogen peroxide is present in an amount of about 14 weight percent.

7. The method of alternative 3, wherein the sodium dihydrogen citrate is present in an amount such that the composition has a pH from about 4.0 to about 5.0.

8. The method of alternative 3, wherein the sodium dihydrogen citrate is present in an amount such that the composition has a pH of about 4.5.

9. The method of alternative 3, wherein the sodium dihydrogen citrate is present in an amount of about 0.1% w/v to about 20% w/v.

10. The method of alternative 3, wherein the SLSA is present in an amount of about 0.01% w/v to about 5% w/v.

11. The method of alternative 3, wherein the SLSA is present in an amount of about 0.25% w/v.

12. The method of alternative 3, wherein the alkyl glucoside is present in an amount of about 0.01% w/v to about 5% w/v.

13. The method of alternative 3, wherein the alkyl glucoside is present in an amount of about 0.25% w/v.

14. The method of alternative 3, wherein the composition comprises hydrogen peroxide in an amount of about 3 weight percent to about 60 weight percent; sodium dihydrogen citrate in an amount such that the composition has a pH from about 4.0 to about 5.0; SLSA in an amount of about 0.01% w/v to about 5% w/v; and/or alkyl glucoside present in an amount of about 0.01% w/v to about 5% w/v.

15. The method of alternative 3, wherein the composition comprises hydrogen peroxide in an amount of about 14 weight percent; sodium dihydrogen citrate in an amount such that the composition has a pH of about 4.5; SLSA in an amount of about 0.25% w/v; and/or alkyl glucoside present in an amount of about 0.25% w/v.

16. The method of alternative 1, wherein the volatile gas is a lachrymatory agent.

17. The method of alternative 1, wherein the volatile gas is an enzymatic product of sulfenic acid.

18. The method of alternative 1, wherein the volatile gas is syn-propanethial-S-oxide or syn-butanethial S-oxide.

19. The method of alternative 1, wherein the food product is an onion, a shallot, a garlic, a leek, or a chive.

20. The method of alternative 1, wherein contacting comprises misting, spraying, coating, dusting, dipping, immersing, soaking, the food product with the composition.

21. The method of alternative 1, wherein contacting comprises cutting the food product with an instrument having the composition thereon.

22. The method of alternative 21, wherein the instrument is a blade, a knife, a chopper, or a slicer.

23. The method of alternative 1, wherein the method prevents or mitigates a lachrymatory response in an individual caused by the volatile gas.

24. The method of alternative 1, wherein contacting the food product with the composition oxidizes the volatile gas and/or oxidizes an enzyme responsible for generating the volatile gas.

25. The method of alternative 1, wherein contacting the food product with the composition occurs prior to, during, or after processing of the food product.

26. The method of alternative 25, wherein processing the food product comprises slicing, dicing, chopping, cutting, mincing, shearing, crushing, or macerating the food product.

27. A method of inhibiting or reducing release of volatile gas from an onion, comprising spraying the onion with a composition comprising: hydrogen peroxide in an amount of about 3 weight percent to about 60 weight percent; sodium dihydrogen citrate in an amount such that the composition has a pH of about 4.0 to about 5.0; sodium lauryl sulfoacetate in an amount of about 0.01% w/v to about 5% w/v; and/or alkyl glucoside such as cetearyl glucoside in an amount of about 0.01% w/v to about 5% w/v.

28. A kit for cutting a food product with reduced release of a volatile gas, the kit comprising: an instrument for cutting the food product; and a container comprising a composition comprising an inhibitor of the volatile gas.

29. The kit of alternative 28, wherein the container is an aerosol bottle comprising the composition.

30. A composition for use in the inhibition or reduction of a volatile gas from a cut food product, the composition comprising a volatile gas inhibitor.

31. The composition for use according to alternative 30, wherein the composition comprises: hydrogen peroxide present in an amount ranging from about 3 weight percent to about 60 weight percent; sodium dihydrogen citrate in an amount such that the composition has a pH of about 4.0 to about 5.0; sodium lauryl sulfoacetate (SLSA) in an amount of about 0.01% w/v to about 5% w/v; and/or cetearyl glucoside in an amount of about 0.01% w/v to about 5% w/v.

32. The composition for use according to alternative 30, wherein the composition comprises hydrogen peroxide present in an amount percent of about 14 weight percent; sodium dihydrogen citrate in an amount such that the composition has a pH of about 4.5; SLSA in an amount of about 0.25% w/v; and/or cetearyl glucoside in an amount of about 0.25% w/v.

33. The composition for use according to alternative 30, wherein the volatile gas comprises a lachrymatory agent.

34. The composition for use according to alternative 30, wherein the volatile gas comprises syn-propanethial-S-oxide or syn-butanethial S-oxide.

35. The composition for use according to alternative 30, wherein the food product is an onion, a garlic, a shallot, a leek, or a chive.

36. The composition for use according to alternative 30, wherein the composition is formulated as a spray, an aerosol, a mist, or a solution.

37. The composition for use according to alternative 30, wherein the composition is formulated as a solid, and wherein volatile gas inhibitor is complexed with a starch, a modified starch, a simple sugar, or a modified sugar.

38. The composition for use according to alternative 37, wherein the composition is formulated as a powder.

39. The composition for use according to alternative 30, wherein the composition further comprises a stabilizer.

40. The composition for use according to alternative 39, wherein the stabilizer is an alcohol or an acid.

41. The composition for use according to alternative 30, wherein the composition oxidizes the volatile gas when the food product is cut, thereby preventing a lachrymatory response in an individual.

42. The composition for use according to alternative 30, wherein the composition oxidizes an enzyme that generates the volatile gas, thereby preventing generation of the volatile gas.

43. The composition for use according to alternative 42, wherein the enzyme is an alliinase or a lachrymatory factor synthase (LFS).

### BRIEF DESCRIPTION OF THE DRAWINGS

FIG. 1 depicts the chemical compounds and enzymes involved in the generation of syn-propanethial S-oxide. Cysteine forms alliin, which is enzymatically modified by alliinase to various sulfenic acids. One sulfenic acid, 1-propenesulfenic acid, is rearranged by the enzyme lachrymatory factor synthase (LFS) to generate syn-propanethial S-oxide.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein. All references cited herein are expressly incorporated by reference herein in their entirety and for the specific disclosure referenced herein.

Embodiments provided herein related to compositions that reduce, inhibit, or ameliorate lachrymatory responses in an individual that occur when food products capable of producing noxious gases are cut. In particular, the present disclosure relates to formulations including an agent that is capable of oxidizing or neutralizing volatile gases or inhibiting or reducing function of an enzyme in the food product that is responsible for generating volatile gases when the food product is cut, wherein the formulations are safe for contact and exposure to food, and do not alter the flavor or appearance of the food. The agent may include an oxidant, a protonation agent, an anionic surfactant, or a non-ionic surfactant. The formulations thereby reduce, mitigate, or prevent pain or tears that are associated with lachrymatory responses in an individual upon cutting food products that release volatile gases upon being cut.

In some embodiments, the compositions include a compound that oxidizes the noxious gases or that oxidizes enzymes that produce the noxious gases. Also provided are uses of the compositions for preventing or reducing the release of noxious gases and for prevention or reduction of lachrymatory responses in an individual. The compositions may be formulated as a powder, spray, mist, aerosol, or solution for contacting or exposing the food product to the composition prior to, during, or after processing of the food product, such as prior to, during, or after chopping, slicing, cutting, shearing, dicing, mincing, crushing, macerating or otherwise preparing the food product.

It will be readily understood that the aspects of the present disclosure, as generally described herein, can be arranged, substituted, combined, separated, and designed in a wide variety of different configurations, all of which are explicitly contemplated herein.

Unless defined otherwise, technical and scientific terms used herein have the same meaning as commonly understood by one of ordinary skill in the art to which the present disclosure belongs. All patents, applications, published applications and other publications referenced herein are expressly incorporated by reference in their entireties unless stated otherwise. For purposes of the present disclosure, the following terms are defined below.

By “about” is meant a quantity, level, value, number, frequency, percentage, dimension, size, amount, weight or length that varies by as much as 30, 25, 20, 15, 10, 9, 8, 7, 6, 5, 4, 3, 2 or 1% to a reference quantity, level, value, number, frequency, percentage, dimension, size, amount, weight or length. When a value is preceded by the term about, the component is not intended to be limited strictly to that value, but it is intended to include amounts that vary from the value.

Throughout this specification, unless the context requires otherwise, the words “comprise,” “comprises,” and “comprising” will be understood to imply the inclusion of a stated step or element or group of steps or elements but not the exclusion of any other step or element or group of steps or elements.

Some embodiments provided herein relate to a method of inhibiting or reducing release of a volatile gas from a food product. In the ordinary course of preparation, volatile gases may be released from a food product, generating a lachrymatory response. As used herein a “lachrymatory response” has its ordinary meaning as understood in light of the specification, and refers to a response of an individual to a volatile gas, wherein the volatile gas activates nociceptors in the eye, resulting in pain, irritation, or tears.

As used herein the terms “inhibit,” “inhibiting,” or “inhibition” have their ordinary meaning as understood in light of the specification, and refers to the reducing or preventing release of a volatile gas from a food product, or reducing or preventing an enzyme functioning that generates a volatile gas. This reduction may occur by an action on the volatile gas itself or an action on an enzyme that generates the volatile gas. As used herein, the terms “reduce,” “reducing,” or “reduction” have their ordinary meaning as understood in light of the specification, and refers to a decreasing, lowering, or slowing an event, such as reducing a release of a volatile gas or a formation of a volatile gas, reducing a function of an enzyme that generates a volatile gas, or reducing a lachrymatory response. The reduction can be a reduction of 10%, 20%, 30%, 40%, 50%, 60%, 70%, 80%, 90%, 100%, or an amount within a range defined by any two of the aforementioned values. The terms inhibit and reduce are not to be construed as necessarily indicating a 100% inhibition or reduction. A partial inhibition or reduction may be realized.

In some embodiments, the volatile gas or a portion of the volatile gas is oxidized, protonated, or otherwise neutralized. In some embodiments, the enzyme that generates the volatile gas, or a portion of the enzyme that generates the volatile gas is oxidized, protonated, or otherwise neutralized. As used herein, “oxidation” has its ordinary meaning as understood in light of the specification, and refers to any reaction that includes loss of electrons. Oxidation may be achieved by an oxidizing agent. An oxidizing agent may correspond to any chemical species that removes electron(s) from another species. As used herein, “protonation” has its ordinary meaning as understood in light of the specification, and refers to addition of a proton to a molecule. Protonation may be achieved with a protonation agent, an agent capable of donating a proton. As used herein, “neutralize” has its ordinary meaning as understood in light of the specification, and refers to an ability of an agent to inhibit (partially or completely), reducing, or abolishing an activity of a compound, such as of a noxious gas.

As used herein, the term “volatile gas” has its ordinary meaning as understood in light of the specification, and refers to a noxious gas that is generated by an enzyme and that is released from a food product. The terms volatile gas, noxious gas, or irritating gas are used interchangeably throughout this specification, and generally refer to a gas that is a lachrymatory agent, acting on the eyes to trigger tearing and stinging upon contact with the eyes. Examples of volatile gases that are described herein include, for example, syn-propanethial-S-oxide, syn-butanethial S-oxide, or other volatile gas known or to be discovered that is released from a vegetable and that is responsible for causing a lachrymatory response in an individual.

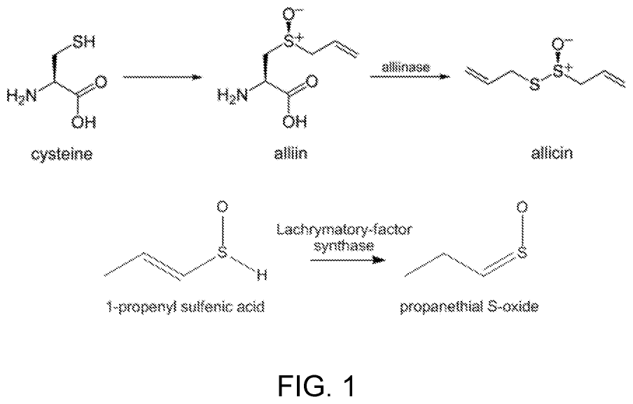

By way of example, volatile gases are generated when onion cells are damaged by the action of a knife, which liberates enzymes called alliinases. As shown in FIG. 1, these enzymes break down chemicals known as amino acid sulfoxides present within the onion, generating chemicals containing the sulfenic acid functional group. A specific sulfenic acid, 1-propenesulfenic acid, forms when onions are cut and reacts to form allicin, also referred to herein as diallyl thiosulfinate. Allicin is rapidly rearranged by a second enzyme, lachrymatory factor synthase (LFS), generating syn-propanethial S-oxide, a member of the sulfine chemical group. Syn-propanethial S-oxide is a low molecular weight volatile chemical that diffuses through the air until it contacts the eyes of an individual. There, the syn-propanethial S-oxide acts as an intense irritant, activating nociceptors in the eye. When activated, these pain and damage sensing organs signal the tear glands to produce secretions designed to flush the irritating chemical from the eye.

Sulfines are unique functional groups with a rich and varied chemistry. Embodiments of the present disclosure relate to inhibiting, reducing, or preventing generation or emission of the noxious gases, including sulfines such as syn-propanethial-S-oxide. Preventing, reducing, or inhibiting the generation or emission of the noxious gas may be achieved by: oxidizing or neutralizing the sulfur atom present in the noxious gas to a higher oxidation state to immobilize the compound or transform it into a non-irritating material; or oxidizing or neutralizing the noxious gas to release the sulfur atom from the noxious gas.

The sulfine functional group is highly electron rich and can serve as a substrate for oxidation. Oxidation at the sulfur atom can result in the conversion of this functional group to a sulfinic acid or a sulfonic acid. In an alternative process, oxidation of a sulfine can lead to expulsion of the sulfur atom from the structure, converting it to an aldehyde or ketone. Although not wishing to be bound by theory, the irritating syn-propanethial-S-oxide can be eliminated through oxidation of the lone sulfur atom.

As used herein, a “food product” has its ordinary meaning as understood in light of the specification and refers to a food that releases or is capable of releasing a volatile gas that causes or is capable of causing a lachrymatory response in an individual upon processing. Examples of such food products include, for example, vegetables such as onions, garlic, shallots, leeks, chives, or scallions, or any vegetable within the genus Allium, including, for example, Allium cepa, Allium sativum, Allium schoenoprasum or Allium siculum.

In some embodiments, the method of inhibiting or reducing the release of a volatile gas from a food product includes contacting the food product with a composition comprising an inhibitor of the volatile gas. As used herein, the terms “contact” or “contacting” have their ordinary meaning as understood in light of the specification, and refers to exposing the food product to the composition, such that the active components of the composition are capable of preventing or reducing the generation of a volatile gas or release of a volatile gas from the food product. Thus, for example, contact may refer to spraying, misting, coating, layering, dusting, dipping, immersing, or soaking the food product with the composition. In some embodiments, the composition is integrated onto, coated onto, or otherwise associated with an instrument used for processing the food product, such that when the food product is processed with the treated instrument, the method of reducing or inhibiting the release or generation of the noxious gas is carried out. For example, in some embodiments, the instrument is a knife, a blade, a chopper, a slicer, a dicer, or other common instrument for cutting, and the instrument is first contacted with the composition, and then used to cut the food product, such that upon cutting, the composition contacts the food product and the noxious gas is prevented from being released or is prevented from being generated.

In some embodiments, the composition is formulated as a solid or as a liquid. In a solid formulation, the composition may be prepared as a powder, such that the composition may be dusted, coated, layered, or sprinkled onto the food product. In some embodiments, the composition is formulated as an aerosol, a spray, or as a solution, such that the composition may be sprayed, misted, coated, contacted, or used for immersing with the food composition. A person of skill in the art will recognize that any suitable formulation may be used such that the composition may be sufficiently exposed to the food product in a way that reduces or prevents generation of or release of the volatile gas.

Some embodiments provided herein relate to methods of preventing, reducing, or mitigating a lachrymatory response in an individual. In some embodiments, the methods include contacting a food product that typically produces noxious gases with a composition as described herein, and processing the food product, such as by cutting or preparing the food product. In some embodiments, the composition prevents or reduces the generation or release of a volatile gas from the food product, such that no irritation, tears, or pain are experienced by the individual when the food product is processed, thereby preventing, reducing, or mitigating a lachrymatory response in the individual.

Oxidation Compositions

In some embodiments, the composition includes an inhibitor of a volatile gas. In some embodiments, the inhibitor of the volatile gas is an oxidant capable of inhibiting or reducing the generation or release of the volatile gas from the food product. In some embodiments, the oxidant is hydrogen peroxide, or an analogue thereof. For example, when the composition is formulated as a solution or spray, the composition may include hydrogen peroxide, present in an amount of about 0.001 weight percent to about 60 weight percent, for example, 0.001, 0.005, 0.01, 0.05, 0.1, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 weight percent, or in an amount within a range defined by any two of the aforementioned values. The composition when formulated as a solution can be applied to the cut surface of a food product using an aerosol bottle, by soaking, or by coating with the solution.

In some embodiments, when the composition is formulated as a solid, the hydrogen peroxide is present complexed with urea, as carbamide peroxide, or as sodium percarbonate, and may be present in an amount ranging from about 0.001 weight percent to about 60 weight percent, for example, 0.001, 0.005, 0.01, 0.05, 0.1, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 weight percent, or in an amount within a range defined by any two of the aforementioned values. The composition when formulated as a solid, such as with carbamide peroxide or sodium percarbonate can be applied as a powder, either in pure form, or diluted with an inert food ingredient such as a starch. Examples of food materials which contain a high proportion of sugar or starch include sucrose, maltodextrin, wheat flour, rye flower, corn starch, arrowroot powder, and rice flour.

In any of these embodiments, the composition used may be in a non-toxic and food acceptable formulation, such that the food product may still be ingested without presenting any toxic side-effects, and also without altering the flavor, appearance, or desirable properties of the food. Without wishing to be bound by theory, when the treated food product is cooked, residual hydrogen peroxide applied in any chemical form will break down to oxygen gas and water. Excess hydrogen peroxide may also be consumed during the cooking process through the oxidation of cysteine found in the protein component of numerous raw food materials to cysteine, itself a common protein component. If peroxide carbamide is selected as the oxidant, urea will be introduced into the food along with hydrogen peroxide. Much of the urea will be converted to ammonia and carbon dioxide by the cooking process. Urea is also a naturally occurring material commonly found in meats and fish, and thus does not present a danger to a person who consumes the finished product. If sodium percarbonate is selected as the oxidant, sodium carbonate will be introduced into the food along with hydrogen peroxide. Sodium carbonate enjoys Generally Recognized as Safe (GRAS) status for inclusion in food. Reduction in the salt added to the dish being prepared may be needed as sodium percarbonate will naturally contribute sodium ion to the finished product.

Hydrogen peroxide in any form is capable of modifying the enzymes responsible for the generation and release of syn-propanethial-S-oxide, including modifying or oxidizing alliinase or LFS. Hydrogen peroxide is capable of oxidizing both amine and sulfhydryl functional groups present within the amino acid residues of the noxious gas generating enzymes. Specifically, hydrogen peroxide may oxidize sulfhydryl groups to sulfinic acids or further to sulfonic acids while amines may be oxidized by hydrogen peroxide to amine-N-oxides. Oxidation of these two functional groups interfere with the ability of the amine and sulfhydryl functional groups to engage in hydrogen bonding. The hydrogen bonds are a vital part of enzymes functioning due to their structural conformation. Loss of the hydrogen bonding capacity of native amine and sulfhydryl functional groups cause the enzymes to alter its three dimensional conformation, greatly reducing or entirely eliminating the enzymatic activity responsible for the generation of syn-propanethial-S-oxide.

Protonation Compositions

In some embodiments, the composition includes an inhibitor of a volatile gas. In some embodiments, the inhibitor of the volatile gas is a protonation agent capable of inhibiting or reducing the generation or release of the volatile gas from the food product. In some embodiments, the protonation agent is an organic acid, including, for example, any organic acid that may be used in the food industry, and that is safe for human consumption. In some embodiments, the protonation agent is a carboxylic acid, sodium gluconate, citric acid, sodium dihydrogen citrate, or any other suitable organic acid, including analogues thereof. In some embodiments, when the composition is formulated as a solution or spray, the composition includes sodium dihydrogen citrate, present in an amount sufficient such that the composition has a pH of about 4.7 or lower, for example, 4.7, 4.65, 4.6, 4.55, 4.5, 4.45, 4.4, 4.35, 4.3, 4.25, 4.2, 4.15, 4.1, 4.05, 4.0, 3.95, 3.9, 3.85, 3.8, 3.75, 3.7, 3.65, 3.6, 3.55, 3.5, 3.45, 3.4, 3.35, 3.3, 3.25, 3.2, 3.15, 3.1, 3.05, or 3.0 or lower, or at a pH within a range defined by any two of the aforementioned values. In some embodiments, a quantity of sodium dihydrogen citrate sufficient to generate a composition having a pH as set forth herein is in an amount ranging from 0.1% w/v to about 20% w/v, such as 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, or 20% w/v, or in an amount within a range defined by any two of the aforementioned values. The composition when formulated as a solution can be applied to the cut surface of a food product using an aerosol bottle, by soaking, or by coating with the solution.

In some embodiments, when the composition is formulated as a solid, the organic acid, such as sodium dihydrogen citrate is formulated as a solid or powder for application as a powder, either in pure form, or diluted with an inert food ingredient such as a starch. Examples of food materials which contain a high proportion of sugar or starch include sucrose, maltodextrin, wheat flour, rye flower, corn starch, arrowroot powder, and rice flour.

In any of these embodiments, the composition used may be in a non-toxic and food acceptable formulation, such that the food product may still be ingested without presenting any toxic side-effects, and also without altering the flavor, appearance, or desirable properties of the food. Without wishing to be bound by theory, when the treated food product is cooked, residual organic acid, such as sodium dihydrogen citrate, applied in any chemical form will break down. Excess organic acid, such as sodium dihydrogen citrate, may also be consumed during the cooking process.

The organic acid used in the composition, such as sodium dihydrogen citrate, in any form is capable of modifying the enzymes responsible for the generation and release of syn-propanethial-S-oxide, including modifying alliinase or LFS. Modification, including inhibition of the enzyme, through the use of the organic acid takes place through a protonation reaction, wherein at an appropriate pH (such as a pH of about 4.7 or lower), a carboxylic acid functional group on the enzyme is protonated, rendering the functional groups on the enzymes less available for hydrogen bond interactions, thereby disrupting the three-dimensional structure of the enzyme, and causing it to have reduced or eliminated activity. In turn, the rate of production of the noxious gas is reduced or eliminated.

Anionic Surfactant Compositions

In some embodiments, the composition includes an inhibitor of a volatile gas. In some embodiments, the inhibitor of the volatile gas is an anionic surfactant capable of inhibiting or reducing the generation or release of the volatile gas from the food product. In some embodiments, the anionic surfactant is any anionic surfactant that may be used in the food industry, and that is safe for human consumption. In some embodiments, the anionic surfactant is sodium lauroyl sarcosinate, sodium cocoyl glutamate, sodium lauryl (dodecyl) sulfate (SDS), sodium laureth sulfate (SLES), or sodium lauryl sulfoacetate (SLSA). In some embodiments, when the composition is formulated as a solution or spray, the composition includes SLSA, present in an amount from about 0.01% w/v to about 5% w/v, such as 0.01, 0.05, 0.1, 0.2, 0.3, 0.4, 0.5, 0.6, 0.7, 0.8, 0.9, 1, 2, 3, 4, or 5% w/v, or in an amount within a range defined by any two of the aforementioned values. The composition when formulated as a solution can be applied to the cut surface of a food product using an aerosol bottle, by soaking, or by coating with the solution.

In some embodiments, when the composition is formulated as a solid, the anionic surfactant, such as SLSA is formulated as a solid or powder for application as a powder, either in pure form, or diluted with an inert food ingredient such as a starch. Examples of food materials which contain a high proportion of sugar or starch include sucrose, maltodextrin, wheat flour, rye flower, corn starch, arrowroot powder, and rice flour.

In any of these embodiments, the composition used may be in a non-toxic and food acceptable formulation, such that the food product may still be ingested without presenting any toxic side-effects, and also without altering the flavor, appearance, or desirable properties of the food. Without wishing to be bound by theory, when the treated food product is cooked, residual anionic surfactant, such as SLSA, applied in any chemical form will break down. Excess anionic surfactant, such as SLSA, may also be consumed during the cooking process.

The anionic surfactant used in the composition, such as SLSA, in any form is capable of modifying the enzymes responsible for the generation and release of syn-propanethial-S-oxide, including modifying alliinase or LFS. Modification, including inhibition of the enzyme, through the use of the anionic surfactant takes place through interrupting the hydrogen bond interactions of the enzyme. Surfactants containing negatively charged functional groups are capable of serving as the source of donor electrons. Functional groups such as carboxylic acids and sulfonic acids are effective in this role, rendering the functional groups on the enzymes less available for hydrogen bond interactions, thereby disrupting the three-dimensional structure of the enzyme, and causing it to have reduced or eliminated activity. In turn, the rate of production of the noxious gas is reduced or eliminated.

Non-Ionic Surfactant Compositions

In some embodiments, the composition includes an inhibitor of a volatile gas. In some embodiments, the inhibitor of the volatile gas is a non-ionic surfactant capable of inhibiting or reducing the generation or release of the volatile gas from the food product. In some embodiments, the non-ionic surfactant is any non-ionic surfactant that may be used in the food industry, and that is safe for human consumption. In some embodiments, the non-ionic surfactant is an alkyl glucoside, such as cetearyl glucoside. In some embodiments, when the composition is formulated as a solution or spray, the composition includes cetearyl glucoside present in an amount from about 0.01% w/v to about 5% w/v, such as 0.01, 0.05, 0.1, 0.2, 0.3, 0.4, 0.5, 0.6, 0.7, 0.8, 0.9, 1, 2, 3, 4, or 5% w/v, or in an amount within a range defined by any two of the aforementioned values. The composition when formulated as a solution can be applied to the cut surface of a food product using an aerosol bottle, by soaking, or by coating with the solution.

In some embodiments, when the composition is formulated as a solid, the non-ionic surfactant, such as cetearyl glucoside, is formulated as a solid or powder for application as a powder, either in pure form, or diluted with an inert food ingredient such as a starch. Examples of food materials which contain a high proportion of sugar or starch include sucrose, maltodextrin, wheat flour, rye flower, corn starch, arrowroot powder, and rice flour.

In any of these embodiments, the composition used may be in a non-toxic and food acceptable formulation, such that the food product may still be ingested without presenting any toxic side-effects, and also without altering the flavor, appearance, or desirable properties of the food. Without wishing to be bound by theory, when the treated food product is cooked, residual non-ionic surfactant, such as cetearyl glucoside, applied in any chemical form will break down. Excess non-ionic surfactant, such as cetearyl glucoside, may also be consumed during the cooking process.

The non-ionic surfactant used in the composition, such as cetearyl glucoside, in any form is capable of modifying the enzymes responsible for the generation and release of syn-propanethial-S-oxide, including modifying alliinase or LFS. Modification, including inhibition of the enzyme, through the use of the non-ionic surfactant takes place through interrupting the hydrogen bond and hydrophobic interactions of the enzyme. Alkyl glucoside surfactants are low in toxicity and highly effective at disturbing hydrophobic interactions, rendering the functional groups on the enzymes less available for hydrogen bond interactions, thereby disrupting the three-dimensional structure of the enzyme, and causing it to have reduced or eliminated activity. In turn, the rate of production of the noxious gas is reduced or eliminated.

Combination Compositions

In some embodiments, the composition includes an inhibitor of a volatile gas. In some embodiments, the inhibitor of the volatile gas is an oxidant, a protonation agent, an anionic surfactant, or a non-ionic surfactant, or any combination thereof, capable of inhibiting or reducing the generation or release of the volatile gas from the food product. The selection of the combination of inhibitors is dependent upon the compatibility of each inhibitor with the other, such that the ability of each inhibitor to reduce the formation of a noxious gas (such as by inhibiting the noxious gas itself or by prevention formation of the noxious gas by inhibiting an enzyme involved in the formation of the noxious gas) is retained. Thus, for example, the composition may include: a) an oxidant, such as hydrogen peroxide present in an amount of 0.001 weight percent to about 60 weight percent, for example, 0.001, 0.005, 0.01, 0.05, 0.1, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 weight percent, or in an amount within a range defined by any two of the aforementioned values; b) a protonation agent, such as sodium dihydrogen citrate present in an present in an amount sufficient such that the composition has a pH of about 4.7 or lower, for example, 4.7, 4.65, 4.6, 4.55, 4.5, 4.45, 4.4, 4.35, 4.3, 4.25, 4.2, 4.15, 4.1, 4.05, 4.0, 3.95, 3.9, 3.85, 3.8, 3.75, 3.7, 3.65, 3.6, 3.55, 3.5, 3.45, 3.4, 3.35, 3.3, 3.25, 3.2, 3.15, 3.1, 3.05, or 3.0 or lower, or at a pH within a range defined by any two of the aforementioned values, or in an amount from 0.1% w/v to about 20% w/v, such as 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, or 20% w/v, or in an amount within a range defined by any two of the aforementioned values; c) an anionic surfactant, such as SLSA present in an amount from about 0.01% w/v to about 5% w/v, such as 0.01, 0.05, 0.1, 0.2, 0.3, 0.4, 0.5, 0.6, 0.7, 0.8, 0.9, 1, 2, 3, 4, or 5% w/v, or in an amount within a range defined by any two of the aforementioned values; or d) a non-ionic surfactant, such as cetearyl glucoside present in an amount from about 0.01% w/v to about 5% w/v, such as 0.01, 0.05, 0.1, 0.2, 0.3, 0.4, 0.5, 0.6, 0.7, 0.8, 0.9, 1, 2, 3, 4, or 5% w/v, or in an amount within a range defined by any two of the aforementioned values; or any combination thereof in any quantity thereof.

The compositions and methods described herein allow individuals to cut or otherwise process food products, such as an onion, without experiencing eye irritation, and without the need to employ impractical, unattractive, or other burdensome measures. Application of the compositions to exposed surfaces of the cut food product neutralizes the noxious gas and leaves the user free to cut the food product without the distraction of tears and irritation.

Some embodiments provided herein relate to a kit that includes any composition as described herein for reducing or preventing the generation or release of volatile gases from a food product. In some embodiments, the kit further includes a cutting instrument, such as a knife, a blade, a slicer, a dicer, or a chopper. In some embodiments, a user contacts a food product that releases or is capable of releasing a volatile gas with the composition, and processes the food with the cutting instrument. In some embodiments, a user contacts the cutting instrument with the composition prior to or during use of the cutting instrument.

### EXAMPLES

Embodiments of the present disclosure are further defined in the following Examples. It should be understood that these Examples are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims. The disclosure of each reference set forth herein is incorporated herein by reference in its entirety, and for the disclosure referenced herein.

### Example 1

### Use of an Oxidation Spray Composition for the Treatment of Onions

The following example demonstrates the use of an oxidation spray composition to reduce or prevent the formation and release of noxious gases from onions.

A spray composition including hydrogen peroxide in an amount of twelve weight percent was prepared. The composition was formulated as a spray for spraying onto the onion. The composition was sprayed onto the exposed surface of an onion prior to, during, or after processing of the onion in an amount that covered the exposed surface of the onion. As a control, an identical composition was prepared that lacked hydrogen peroxide, and was sprayed onto an exposed surface of a control onion (same onion type). After cutting, both the test and control onion fragments were placed into a colander and rinsed with cold tap water, and added to a cooking vessel.

The onion exposed to the test composition did not release any noxious gases, whereas the onion exposed to the control composition released noxious gases, causing lachrymatory responses in an individual, as is commonly experienced when cutting onions.

### Example 2

### Use of an Oxidation Solid Composition for the Treatment of Onions

The following example demonstrate the use of an oxidation solid composition to reduce or prevent the formation and release of noxious gases from onions.

Two test solid compositions were prepared. The first test composition included finely powdered carbamide peroxide ground with a finely powdered starch. The second test composition included finely powdered sodium percarbonate ground with a finely powdered starch. Each composition was separately applied to an exposed surface of an onion prior to, during, or after processing of the onion. A control composition, including the composition without carbamide peroxide or without sodium percarbonate (powdered starch only) was applied to an exposed surface of a control onion (same onion type). After cutting, the test and control onion fragments were placed into a colander and rinsed with cold tap water, and added to a cooking vessel.

The onions exposed to each test composition did not release any noxious gases, whereas the onion exposed to the control composition released noxious gases, causing lachrymatory responses in an individual, as is commonly experienced when cutting onions.

### Example 3

### Use of a Protonation Spray Composition for the Treatment of Onions

The following example demonstrates the use of a protonation spray composition to reduce or prevent the formation and release of noxious gases from onions.

A spray composition was prepared that included sodium dihydrogen citrate in an amount sufficient to bring the solution to a pH of about 4.7 or less. The composition was formulated as a spray for spraying onto the onion. The composition was sprayed onto the exposed surface of an onion prior to, during, or after processing of the onion in an amount that covered the exposed surface of the onion. As a control, an identical composition was prepared that lacked sodium dihydrogen citrate, and was sprayed onto an exposed surface of a control onion (same onion type). After cutting, both the test and control onion fragments were placed into a colander and rinsed with cold tap water, and added to a cooking vessel.

The onion exposed to the test composition had a reduction in the release of noxious gases, whereas the onion exposed to the control composition released noxious gases had no reduction in the release of noxious gases, causing lachrymatory responses in an individual, as is commonly experienced when cutting onions.

### Example 4

### Use of an Anionic Surfactant Spray Composition for the Treatment of Onions

The following example demonstrates the use of an anionic surfactant spray composition to reduce or prevent the formation and release of noxious gases from onions.

A spray composition was prepared that included sodium lauryl sulfoacetate (SLSA) present in an amount of 0.25% w/v. The composition was formulated as a spray for spraying onto the onion. The composition was sprayed onto the exposed surface of an onion prior to, during, or after processing of the onion in an amount that covered the exposed surface of the onion. As a control, an identical composition was prepared that lacked SLSA, and was sprayed onto an exposed surface of a control onion (same onion type). After cutting, both the test and control onion fragments were placed into a colander and rinsed with cold tap water, and added to a cooking vessel.

The onion exposed to the test composition had a reduction in the release of noxious gases, whereas the onion exposed to the control composition released noxious gases had no reduction in the release of noxious gases, causing lachrymatory responses in an individual, as is commonly experienced when cutting onions.

### Example 5

### Use of a Non-Ionic Surfactant Spray Composition for the Treatment of Onions

The following example demonstrates the use of a non-ionic surfactant spray composition to reduce or prevent the formation and release of noxious gases from onions.

A spray composition was prepared that included an alkyl glycoside (cetearyl glucoside) present in an amount of 0.25% w/v. The composition was formulated as a spray for spraying onto the onion. The composition was sprayed onto the exposed surface of an onion prior to, during, or after processing of the onion in an amount that covered the exposed surface of the onion. As a control, an identical composition was prepared that lacked cetearyl glucoside, and was sprayed onto an exposed surface of a control onion (same onion type). After cutting, both the test and control onion fragments were placed into a colander and rinsed with cold tap water, and added to a cooking vessel.

The onion exposed to the test composition had a reduction in the release of noxious gases, whereas the onion exposed to the control composition released noxious gases had no reduction in the release of noxious gases, causing lachrymatory responses in an individual, as is commonly experienced when cutting onions.

### Example 6

Use of a Combination Spray Composition for the Treatment of Onions

The following example demonstrates the use of a combination spray composition to reduce or prevent the formation and release of noxious gases from onions. A spray composition including any one of the test compositions as set forth in Table 1 is prepared:

TABLE 1
Combination spray formulations

| | | Efficacy on |
|---|---|---|
| Formulation | Components | Noxious Gas |
| 1 - Control | Buffer | No reduction |
| 2 - Oxidation and | Hydrogen peroxide (12% w/w) | Reduction |
| protonation composition | and sodium dihydrogen citrate (pH ≤ 4.7) | |
| 3 - Oxidation and anionic | Hydrogen peroxide (12% w/w) | Reduction |
| surfactant composition | and SLSA (0.25% w/v) | |
| 4 - Oxidation and non-ionic | Hydrogen peroxide (12% w/w) | Reduction |
| surfactant composition | and cetearyl glucoside (0.25% w/v) | |
| 5 - Protonation and anionic | Sodium dihydrogen citrate (pH ≤ 4.7) | Reduction |
| surfactant composition | and SLSA (0.25% w/v) | |
| 6 - Protonation and non- | Sodium dihydrogen citrate (pH ≤ 4.7) | Reduction |
| ionic surfactant composition | and cetearyl glucoside (0.25% w/v) | |
| 7 - Anionic surfactant and | SLSA (0.25% w/v) | Reduction |
| non-ionic surfactant | and cetearyl glucoside (0.25% w/v) | |
| composition | | |
| 8 - Oxidation, protonation, | Hydrogen peroxide (12% w/w), | Reduction |
| and anionic surfactant | sodium dihydrogen citrate (pH ≤ 4.7), | |
| | and SLSA (0.25% w/v) | |
| 9 - Oxidation, protonation, | Hydrogen peroxide (12% w/w), | Reduction |
| and non-ionic surfactant | sodium dihydrogen citrate (pH ≤ 4.7), | |
| | and cetearyl glucoside (0.25% w/v) | |
| 10 - Oxidation, anionic | Hydrogen peroxide (12% w/w), | Reduction |
| surfactant, and non-ionic | SLSA (0.25% w/v) and | |
| surfactant | cetearyl glucoside (0.25% w/v) | |
| 11 - Protonation, anionic | Sodium dihydrogen | Reduction |
| surfactant, and non-ionic | citrate (pH ≤ 4.7), | |
| surfactant | SLSA (0.25% w/v), and | |
| | cetearyl glucoside (0.25% w/v) | |
| 12 - Oxidation, protonation, | Hydrogen peroxide (12% w/w), | Reduction |
| anionic surfactant, and non- | sodium dihydrogen | |
| ionic surfactant | citrate (pH ≤ 4.7), | |
| | SLSA (0.25% w/v), and | |
| | cetearyl glucoside (0.25% w/v) | |

Each composition is formulated as a spray for spraying onto the onion. Each composition is sprayed onto the exposed surface of an onion prior to, during, or after processing of the onion in an amount that covers the exposed surface of the onion. As a control, an identical composition is prepared that lacks hydrogen peroxide, sodium dihydrogen citrate, SLSA, or cetearyl glucoside, and is sprayed onto an exposed surface of a control onion (same onion type). After cutting, both the test and control onion fragments are placed into a colander and rinsed with cold tap water, and added to a cooking vessel.

The onion exposed to the test composition does not release any noxious gases, whereas the onion exposed to the control composition releases noxious gases, causing lachrymatory responses in an individual, as is commonly experienced when cutting onions.

The examples provided herein demonstrate the efficacy of the compositions described herein, including as solid formulations or as liquid formulations, for contacting a food product that is capable of producing volatile gases and preventing the formation and release of the volatile gas from the food product during processing, including cutting and cooking, or the food product.

As used herein, the section headings are for organizational purposes only and are not to be construed as limiting the described subject matter in any way. All literature and similar materials cited in this application, including but not limited to, patents, patent applications, articles, books, treatises, and internet web pages are expressly incorporated by reference in their entirety for any purpose, including the disclosures specifically referenced herein. When definitions of terms in incorporated references appear to differ from the definitions provided in the present teachings, the definition provided in the present teachings shall control.

Although this disclosure has been described in the context of certain embodiments and examples, those skilled in the art will understand that the present disclosure extends beyond the specifically disclosed embodiments to other alternative embodiments and/or uses of the disclosure and obvious modifications and equivalents thereof. In addition, while several variations of the disclosure have been shown and described in detail, other modifications, which are within the scope of this disclosure, will be readily apparent to those of skill in the art based upon this description. It is also contemplated that various combinations or sub-combinations of the specific features and aspects of the embodiments may be made and still fall within the scope of the disclosure. It should be understood that various features and aspects of the disclosed embodiments can be combined with, or substituted for, one another in order to form varying modes or embodiments of the disclosure. Thus, it is intended that the scope of the present disclosure described herein should not be limited by the particular disclosed embodiments described above.

It should be understood, however, that this detailed description, while indicating preferred embodiments, is given by way of illustration only, since various changes and modifications within the spirit and scope will become apparent to those skilled in the art.

The terminology used in the description presented herein is not intended to be interpreted in any limited or restrictive manner. Rather, the terminology is simply being utilized in conjunction with a detailed description of embodiments of the systems, methods and related components. Furthermore, embodiments may comprise several novel features, no single one of which is solely responsible for its desirable attributes or is believed to be essential to practicing the disclosure herein described.

What is claimed is:

1. A method of inhibiting or reducing the release of a volatile gas from a food product, the method comprising contacting the food product with a composition comprising an inhibitor of the volatile gas, wherein the inhibitor of the volatile gas is hydrogen peroxide, sodium dihydrogen citrate, sodium lauryl sulfoacetate (SLSA), or alkyl glucoside such as cetearyl glucoside.

2. The method of claim 1, wherein the hydrogen peroxide is present in an amount ranging from about 3 weight percent to about 60 weight percent.

3. The method of claim 1, wherein the hydrogen peroxide is present in an amount of about 8 weight percent to about 20 weight percent.

4. The method of claim 1, wherein the hydrogen peroxide is present in an amount of about 14 weight percent.

5. The method of claim 1, wherein the sodium dihydrogen citrate is present in an amount such that the composition has a pH from about 4.0 to about 5.0.

6. The method of claim 1, wherein the sodium dihydrogen citrate is present in an amount such that the composition has a pH of about 4.5.

7. The method of claim 1, wherein the sodium dihydrogen citrate is present in an amount of about 0.1% w/v to about 20% w/v.

8. The method of claim 1, wherein the SLSA is present in an amount of about 0.01% w/v to about 5% w/v.

9. The method of claim 1, wherein the SLSA is present in an amount of about 0.25% w/v.

10. The method of claim 1, wherein the alkyl glucoside is present in an amount of about 0.01% w/v to about 5% w/v.

11. The method of claim 1, wherein the alkyl glucoside is present in an amount of about 0.25% w/v.

12. The method of claim 1, wherein the composition comprises hydrogen peroxide in an amount of about 3 weight percent to about 60 weight percent; sodium dihydrogen citrate in an amount such that the composition has a pH from about 4.0 to about 5.0; SLSA in an amount of about 0.01% w/v to about 5% w/v; and/or alkyl glucoside present in an amount of about 0.01% w/v to about 5% w/v.

13. The method of claim 1, wherein the composition comprises hydrogen peroxide in an amount of about 14 weight percent; sodium dihydrogen citrate in an amount such that the composition has a pH of about 4.5; SLSA in an amount of about 0.25% w/v; and/or alkyl glucoside present in an amount of about 0.25% w/v.

14. The method of claim 1, wherein contacting comprises cutting the food product with an instrument having the composition thereon, wherein the instrument is a blade, a knife, a chopper, or a slicer.

15. The method of claim 1, wherein contacting the food product with the composition oxidizes the volatile gas and/or oxidizes an enzyme responsible for generating the volatile gas.

16. The method of claim 1, wherein contacting the food product with the composition occurs prior to, during, or after processing of the food product.

17. The method of claim 16, wherein processing the food product comprises slicing, dicing, chopping, cutting, mincing, shearing, crushing, or macerating the food product.

18. A method of inhibiting or reducing release of volatile gas from an onion, comprising spraying the onion with a composition comprising:
hydrogen peroxide in an amount of about 3 weight percent to about 60 weight percent;
sodium dihydrogen citrate in an amount such that the composition has a pH of about 4.0 to about 5.0;
sodium lauryl sulfoacetate in an amount of about 0.01% w/v to about 5% w/v; and/or
alkyl glucoside such as cetearyl glucoside in an amount of about 0.01% w/v to about 5% w/v.

19. A kit for cutting a food product with reduced release of a volatile gas, the kit comprising:
an instrument for cutting the food product; and
a container comprising a composition comprising an inhibitor of the volatile gas.

20. The kit of claim 19, wherein the container is an aerosol bottle comprising the composition.
